(19) United States
(12) Patent Application Publication
(10) Pub. No.: US 2020/0063621 A1
(43) Pub. Date: Feb. 27, 2020

(54) DEVICE FOR REGULATING DISPLACEMENT

(71) Applicant: MU-SHAN WANG, TAICHUNG CITY (TW)

(72) Inventor: MU-SHAN WANG, TAICHUNG CITY (TW)

(21) Appl. No.: 16/106,669

(22) Filed: Aug. 21, 2018

(51) Int. Cl. F01N 1/16; F01N 13/18; F16K 31/60

(52) U.S. Cl. CPC F01N 1/166; F16K 31/602; F01N 13/1838

(57) ABSTRACT

A displacement regulating device, which is adapted to be disposed on an exhaust pipe body of a vehicle. The displacement regulating device includes a regulating member, which has the function of regulating the displacement of an exhaust pipe and the effect of blocking the noise generated by the exhaust pipe. The displacement regulating device includes an operating device which could be held by a hand to move back and forth of a motorcycle. When the regulating member is operated to be away from the exhaust pipe, the noise volume generated by the exhaust pipe is not restricted. When the regulating member is located adjacent to the exhaust pipe, the noise volume generated by the exhaust pipe could be reduced.

### BACKGROUND OF THE INVENTION

### Technical Field

The present invention relates generally to an exhaust pipe structure of a vehicle, and more particularly to an exhaust pipe with adjustable volume.

### Description of Related Art

Taking a motorcycle as an example of vehicles, when riding a motorcycle on the road, its unique and powerful exhaust sound has always been fascinating. However, the exhaust sound becomes a noise pollution to disturb the people in the middle of the night. Therefore, how to reduce noise when riding a motorcycle at night has become an important issue.

Therefore, some manufacturers in the industry have developed a kind of exhaust pipe that could lower the noise, as disclosed in the Taiwan utility model patent M389161 “Exhaust Pipe with regulable displacement”, which disposes regulating slats in the exhaust pipe. However, such arrangement will be difficult to repair. In addition, in patent M389161, in order to adjust an angle of the slats, the slats disposed inside an outlet is driven by a driving motor and an electronic device. However, using the driving motor and the electronic device will increase the manufacturing cost. Moreover, the high temperature and the sun exposure environment will accelerate the loss of the electronic device.

In light of this, there is a need for the manufacturers to reform an exhaust pipe to lower the noise, lower the manufacturing cost, simplify the maintenance, and reduce environmental impact.

### BRIEF SUMMARY OF THE INVENTION

In view of the above, the primary objective of the present invention is to provide a displacement regulating device, which could reduce the noise generated when an exhaust pipe exhausting.

The present invention provides a displacement regulating device, which is adapted to be disposed on an exhaust pipe body of a vehicle, wherein the exhaust pipe body has at least one outlet. The displacement regulating device includes a regulating member and an operating device, wherein the regulating member is adapted to be movably disposed inside or outside of the exhaust pipe body. The operating device is engaged with the regulating member and is operable to drive the regulating member to move between a first position and a second position, wherein the first position is adjacent to the at least one outlet, and the second position is away from the at least one outlet.

In an embodiment, the regulating member has a first end and a second end which are opposite. When the regulating member is at the second position, the first end is adjacent to a peripheral edge of the at least one outlet of the exhaust pipe body, and the second end of the regulating member and the peripheral edge of the at least one outlet are spaced from each other by a distance.

In an embodiment, the operating device includes an operating member and a linking assembly, and the linking assembly engages the operating member and the regulating member. When the operating member is operated, the linking assembly drives the operating member to move between the first position and the second position.

In an embodiment, the regulating member includes a cover, wherein the cover has the first end and the second end and is controlled by the operating member to pivot around the first end, whereby to move between the first position and the second position.

In an embodiment, the linking assembly includes a movable shaft and an abutting rod, and the movable shaft is engaged with the second end of the cover, wherein the abutting rod is engaged with the movable shaft. When the cover is at the first position, the abutting rod abuts against an outer surface of the cover.

In an embodiment, the linking assembly further includes a restoring member, and the restoring member provides a reverse force to urge the cover to move toward the first position.

In an embodiment, the cover has at least one opening, wherein when the cover is located at the first position, the at least one opening communicates inside and outside of the exhaust pipe body.

In an embodiment, the regulating member includes a cover and a guiding path, and the cover is controlled by the operating member to horizontally move between the first position and the second position via the guiding path.

In an embodiment, the operating device includes an operating member and a linking assembly, and the linking assembly engages the operating member and the regulating member, and has a driven shaft which is driven by the operating member to move relative to the exhaust pipe body. The cover is disposed on the driven shaft, wherein the guiding path includes at least one extending shaft disposed in parallel with the driven shaft. The cover moves along with an extending direction of the at least one extending shaft.

In an embodiment, the driven shaft has a threaded section, and the cover has a threaded hole which is screwed to the threaded section.

In an embodiment, the guiding path includes a plurality of extending shafts, wherein an end of each of the extending shafts is connected to a peripheral edge of the exhaust pipe body, while another end thereof extends outside of the at least one outlet. The cover is located between the extending shafts.

In an embodiment, the linking assembly further includes a restoring member, and the restoring member provides a reverse force to urge the cover to move toward the first position.

In an embodiment, the cover has at least one opening, wherein when the cover is located at the first position, the at least one opening communicates inside and outside of the exhaust pipe body.

In an embodiment, an inner surface of the cover has a protruding portion, and the protruding portion has at least one opening. When the cover is located at the first position, the at least one opening communicates inside and outside of the exhaust pipe body.

In an embodiment, the regulating member includes a sound-absorbing member connected to the cover, and at least a part of the sound-absorbing member is located inside of the exhaust pipe body.

In an embodiment, the regulating member includes a cover and a rotatable shaft, and the cover is engaged with the rotatable shaft. When the cover is controlled by the rotatable shaft to rotate around an axial direction of the rotatable shaft from the second position to the first position, an exhaust gas exhausted from the at least one outlet is gradually shielded by the cover.

In an embodiment, further including an extending tube disposed outside of the at least one outlet, wherein the extending tube is adapted to be engaged with the exhaust pipe body, and the exhaust gas exhausted from the at least one outlet passes through the extending tube.

In an embodiment, when the cover is located at the first position, the cover is located between the extending tube and the exhaust pipe body. When the cover is located at the second position, the cover is not located between the extending tube and the exhaust pipe body.

In an embodiment, the exhaust pipe body includes a main exhaust pipe and an attached exhaust pipe, and the at least one outlet comprises a main outlet and an attached outlet. The main outlet is located on the main exhaust pipe, and the attached outlet is located on the attached exhaust pipe. When the regulating member of the displacement regulating device is located at the first position, the regulating member is adjacent to the main outlet. At this time, a displacement of the main outlet minus a displacement of the attached outlet is defined as a first difference. When the regulating member of the displacement regulating device is located at the second position, the regulating member is away from the main outlet. At this time, the displacement of the main outlet minus the displacement of the attached outlet is defined as a second difference. The first difference is smaller than the second difference.

In an embodiment, an inside of the attached outlet which is adjacent to a peripheral edge of the attached outlet has a sound-absorbing member.

By integrating the exhaust pipe of the vehicle with the displacement regulating device, not only the displacement of the exhaust pipe of the vehicle could be controlled, but also the noise generated by the exhaust pipe body of the vehicle could be effectively reduced.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a side view, showing the motorcycle and the displacement regulating device of a first embodiment according to the present invention;

FIG. 2 is a side view, showing the regulating member which is pivotally connected is located at the first position;

FIG. 3 is a side view, showing the regulating member which is pivotally connected is to be switched from the first position to the second position;

FIG. 4 is a side view, showing the regulating member which is pivotally connected is located at the second position;

FIG. 5 is a perspective view, showing the cover with the notch;

FIG. 6 is a perspective view, showing the cover with the plurality of openings;

FIG. 7 is a side view, showing the regulating member of a second embodiment according to the present invention, which is screwed, is located at the first position;

FIG. 8 is a side view, showing the regulating member which is screwed is to be switched from the first position to the second position;

FIG. 9 is a side view, showing the regulating member which is screwed is located at the second position;

FIG. 10 is a perspective view, showing the cover with the notch;

FIG. 11 is a perspective view, showing the cover with the plurality of openings;

FIG. 12 is a perspective view, showing the cover with the plurality of openings and the sound-absorbing member;

FIG. 13 is a perspective view, showing the cover with the protruding portion;

FIG. 14 is a side view, showing the regulating member which is rotatable is located at the first position;

FIG. 15 is a side view, showing the regulating member which is rotatable is to be switched from the first position to the second position;

FIG. 16 is a side view, showing the regulating member is located at the first position by the operating member of another embodiment according to the present invention;

FIG. 17 is a side view, showing the regulating member is to be switched from the first position to the second position by the operating member of another embodiment according to the present invention; and

FIG. 18 is a side view, showing the regulating member is located at the second position by the operating member of another embodiment according to the present invention.

### DETAILED DESCRIPTION OF THE INVENTION

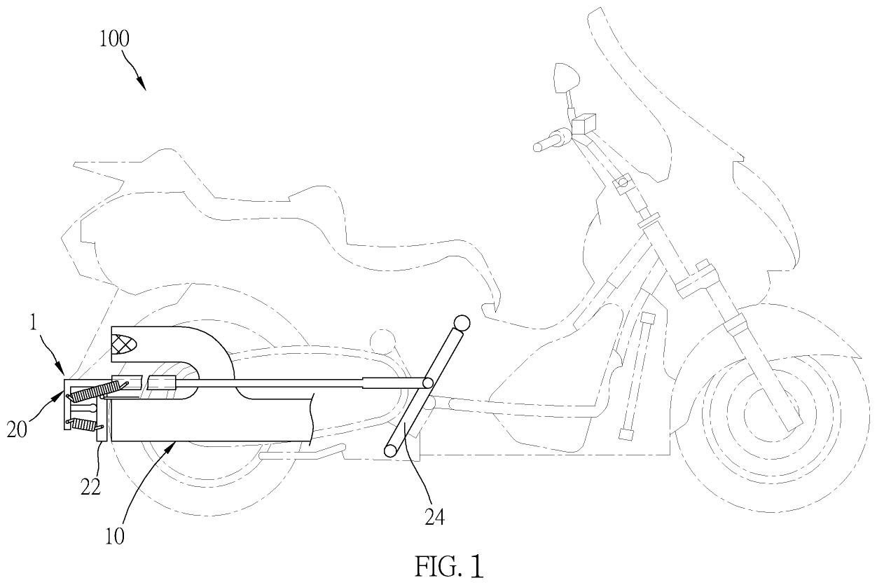

FIG. 1 is a schematic diagram showing a displacement regulating device 1 of a first embodiment according to the present invention and a motorcycle 100 which the displacement regulating device 1 applied to, wherein the displacement regulating device 1 includes a regulating member 22, and an operating device 20, and the motorcycle 100 includes an exhaust pipe body 10. The exhaust pipe body 10 has at least one outlet for exhausting exhaust gas generated by the motorcycle 100 from the exhaust pipe body 10. The operating device 20 is adapted to drive the regulating member 22 to move, whereby to regulate a displacement exhausted from the exhaust pipe body 10.

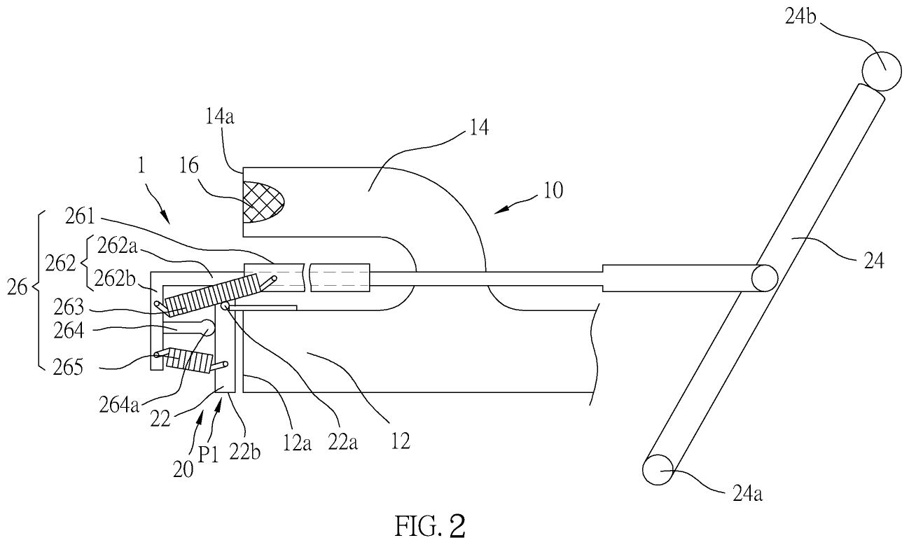

As shown in FIG. 2, in the current embodiment, the exhaust pipe body 10 includes a main exhaust pipe 12 and an attached exhaust pipe 14, wherein the main exhaust pipe 12 has a main outlet 12a, and the attached exhaust pipe 14 has an attached outlet 14a. Both of the main outlet 12a and the attached outlet 14a are circular openings. The main exhaust pipe 12 is used as a main exhaust pipe in a normal state. A sound-absorbing member 16 is disposed in the attached exhaust pipe 14.

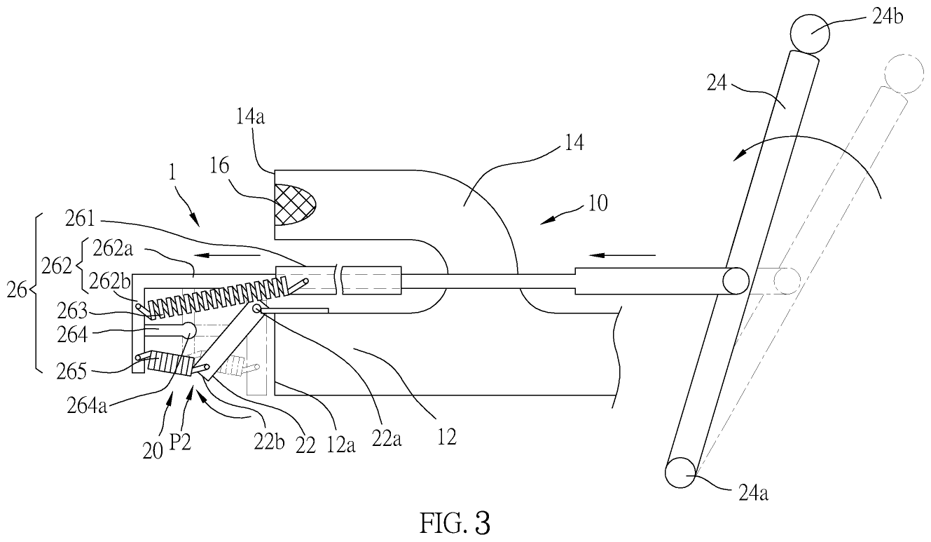

The operating device 20 includes an operating member 24 and a linking assembly 26, wherein the linking assembly 26 links the regulating member 22 and the operating member 24, and is driven by the operating member 24 to drive the regulating member 22 to move between a first position P1 and a second position P2. As shown in FIG. 2, the first position P1 is adjacent to the main outlet 12a, and the second position P2 shown in FIG. 3 is away from the main outlet 12a. The operating device 20 further includes a positioning member (not shown), wherein when the regulating member 22 is located at the second position P2, the operating member 24 is fixed by the positioning member (not shown), so that the operating member 24 could be positioned without being held by a rider, whereby to keep the regulating member 22 at the second position P2.

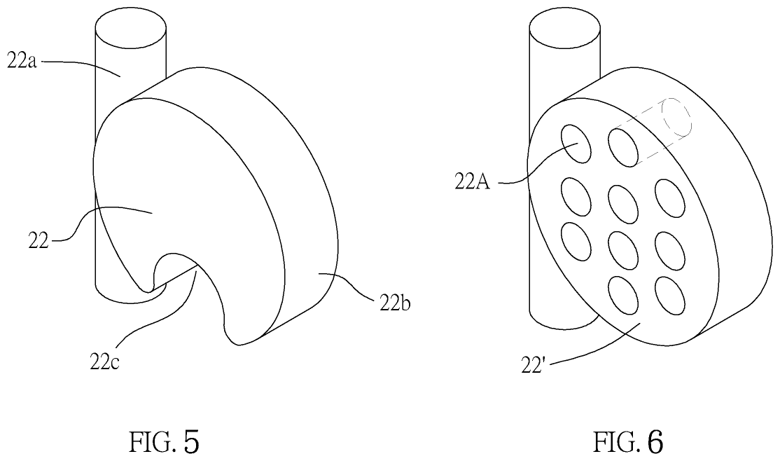

As shown in FIG. 5, in the current embodiment, the regulating member 22 is a cover which is circular. Two opposite ends of the regulating member 22 are respectively defined as a first end 22a and a second end 22b, wherein the first end 22a is pivotally connected to the main exhaust pipe 12 at where adjacent to the main outlet 12a to form a pivot end, and the regulating member 22 is controlled by the operating member 24 to pivot around the pivot end. The second end 22b of the regulating member 22 has a notch 22c. The operating member 24 has a pivot end 24a and a control end 24b which are opposite, wherein the pivot end 24a is pivotally connected to a predetermined portion on the motorcycle 100, and the control end 24b is adapted to be held by a rider's hand for moving the operating member 24 back and forth.

The linking assembly 26 includes a stable tube 261, a movable shaft 262, a restoring member 263, an abutting rod 264, and a spring member 265, wherein the stable tube 261 is fixed on a predetermined portion of the motorcycle 100. The movable shaft 262 includes a flat segment 262a and a bending section 262b, wherein the flat segment 262a passes through the stable tube 261, and an end of the flat segment 262a is pivotally connected to the operating member 24 and is located between the pivot end 24a and the control end 24b of the operating member 24, while another end thereof is connected to the bending section 262b. The bending section 262b is connected to the regulating member 22 at where adjacent to the second end 22b via the spring member 265. The restoring member 263 is a tension spring, and an end of the restoring member 263 is connected to the bending section 262b, while another end thereof is connected to the stable tube 261, wherein a reverse force generated by the restoring member 263 urges the regulating member 22 to move toward the first position P1. An end of the abutting rod 264 is fixed on an inside of the bending section 262b, while another end thereof has a sphere portion 264a extending toward the regulating member 22.

In the aforementioned paragraphs, detailed components and the structures of the present invention are explained, while the manner about how the displacement exhausted from the exhaust pipe body 10 is regulated for reducing the noise will be described in detail as follow, and the performance will be described later.

FIG. 2 shows that the regulating member 22 is located at the first position P1. At this time, the restoring member 263 is in an unstretched state, and a front end of the abutting rod 264 abuts against an outer surface of the regulating member 22, whereby to ensure that the regulating member 22 is maintained at the first position P1.

FIG. 3 shows that the control end 24b of the operating member 24 is moved toward a rear of the motorcycle 100. At this time, the operating member 24 pushes the movable shaft 262 to move toward the rear of the motorcycle 100 and pulls the regulating member 22 outward via the spring member 265. With the pivot end formed on the first end 22a, the regulating member 22 is pivotally moved, and the restoring member 263 is in a stretched state at this time.

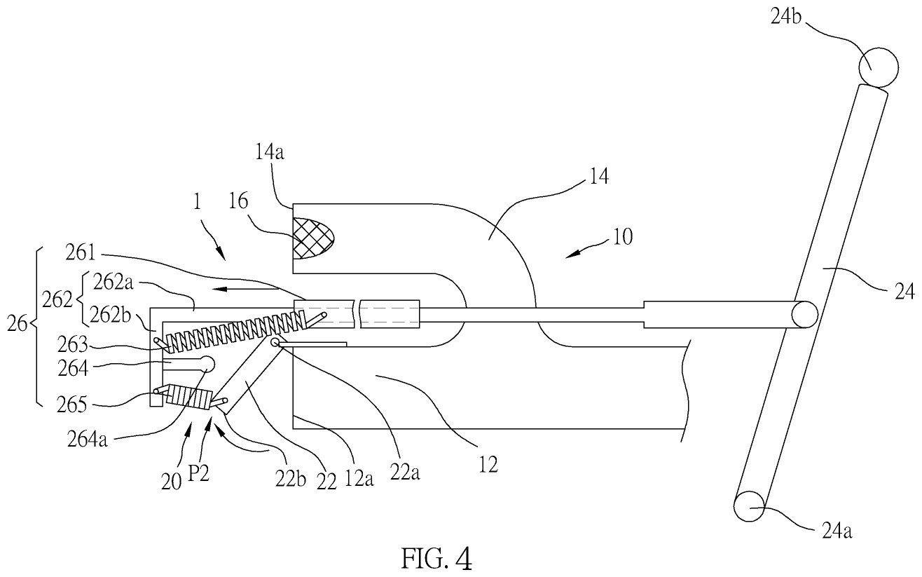

FIG. 4 shows that the regulating member 22 is indirectly driven by the operating member 24 to move to the second position P2. At this time, the restoring member 263 is stretched to store the reverse force for retracting.

During the process of changing the position of the regulating member 22, when the regulating member 22 is located at the first position P1, the regulating member 22 is adjacent to the main outlet 12a. At this time, a part of exhaust gas is blocked by the regulating member 22 to be transferred to the attached exhaust pipe 14, so that exhaust gas is not only exhausted from the notch 22c of the regulating member 22 but also from the attached outlet 14a. At this time, a displacement of the main outlet 12a minus a displacement of the attached outlet 14a is defined as a first difference. When the regulating member 22 is located at the second position P2, the regulating member 22 is away from the main outlet 12a. At this time, exhaust gas is mainly exhausted from the main outlet 12a, and the displacement of the main outlet 12a minus the displacement of the attached outlet 14a is defined as a second difference, wherein the first difference is smaller than the second difference. It shall be noted that no matter the regulating member 22 is located at the first position P1 or at the second position P2, the total amount of the exhausted exhaust gas is not affected. In this way, when the regulating member 22 is located at the first position P1, a part of exhaust gas that is exhausted from the attached outlet 14a could pass through the sound-absorbing member 16 to reduce the noise. On the contrary, when the regulating member 22 is located at the second position P2, since exhaust gas is mainly exhausted from the main outlet 12a, the volume reduction effect of the sound-absorbing member 16 is not significant.

In addition, a regulating member 22′ with another type is illustrated in FIG. 6, wherein the regulating member 22′ is also a circular cover. The difference between the regulating member 22′ and the aforementioned regulating member 22 is that, the regulating member 22′ replaces the notch 22c with a plurality of openings 22A, so that the displacement of the main outlet 12a could be increased, and a sound wave could be effectively prevented from being transmitted from the main outlet 12a.

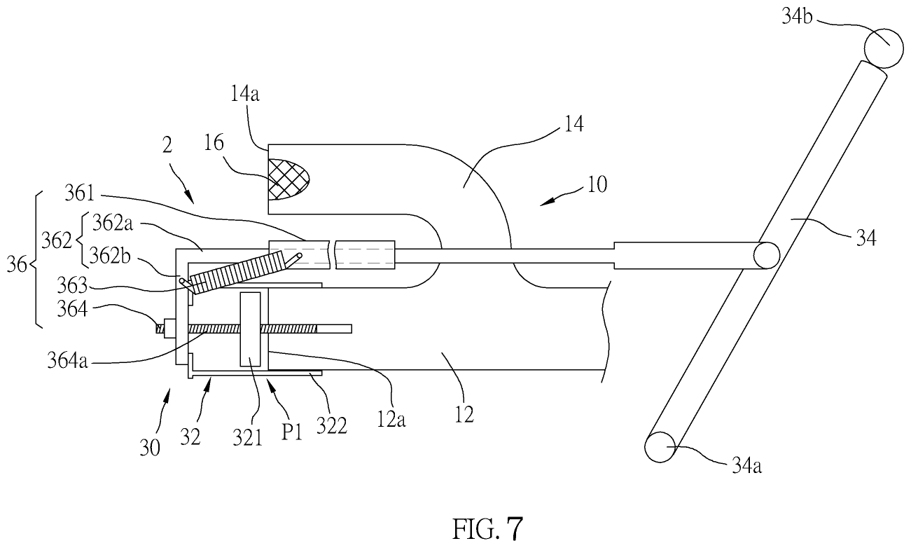

In addition to using the structure of the aforementioned regulating member 22 which is pivotally connected for blocking exhaust gas and changing the flow direction, there are the following embodiments, such as a displacement regulating device 2 of a second embodiment according to the present invention illustrated in FIG. 7 to FIG. 13. The displacement regulating device 2 of the second embodiment is operated based on the concept of a guide.

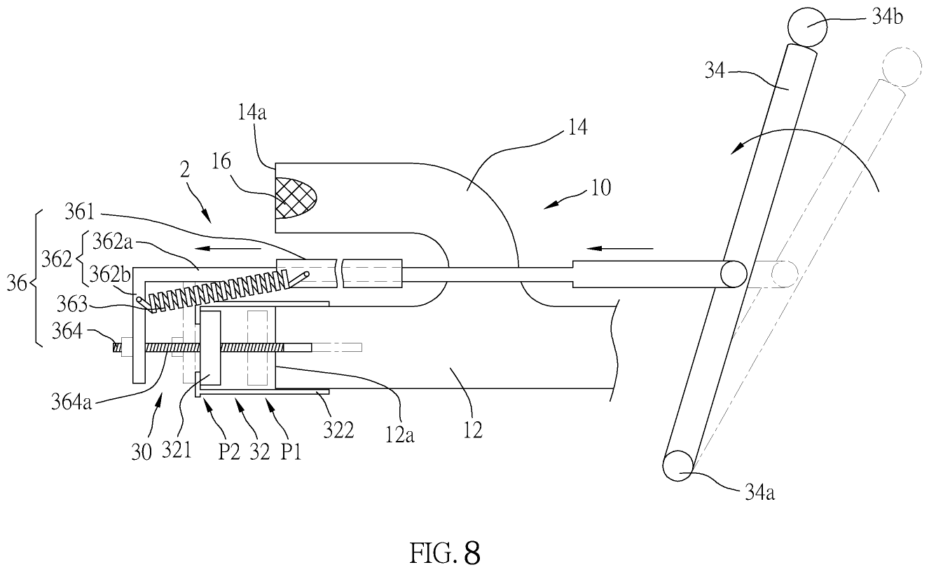

As shown in FIG. 7, an operating device 30 of the displacement regulating device 2 of the second embodiment includes an operating member 34 and a linking assembly 36, wherein the linking assembly 36 links the regulating member 32 and the operating member 34, and is driven by the operating member 34 to drive a regulating member 32 of the displacement regulating device 2 of the second embodiment to move between a first position P1 and a second position P2 of the second embodiment. The first position P1 as shown in FIG. 7 is adjacent to the main outlet 12a, and the second position P2 as shown in FIG. 8 is away from the main outlet 12a. The operating device 30 further includes a positioning member (not shown), wherein when the regulating member 32 is located at the second position P2, the operating member 34 is fixed by the positioning member (not shown), so that the operating member 34 could be positioned without being held by a rider, whereby to keep the regulating member 32 at the second position P2. In the current embodiment, the operating member 34 is the same as the operating member 24 of the first embodiment, and the linking assembly 36 includes a stable tube 361, a movable shaft 362, and a restoring member 363 which are the same as that of the first embodiment. The difference between the displacement regulating device 2 of the second embodiment and that of the first embodiment is that, the abutting rod 264 and the spring member 265 are omitted, and the linking assembly 36 further has a driven shaft 364 which has a threaded section 364a, wherein the driven shaft 364 is connected to the movable shaft 362 and is arranged in parallel with the movable shaft 362.

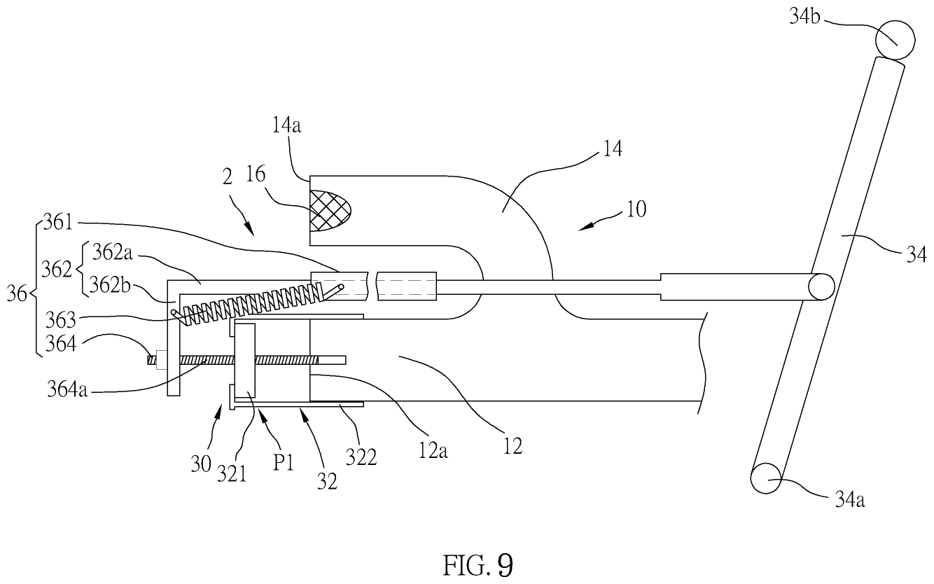

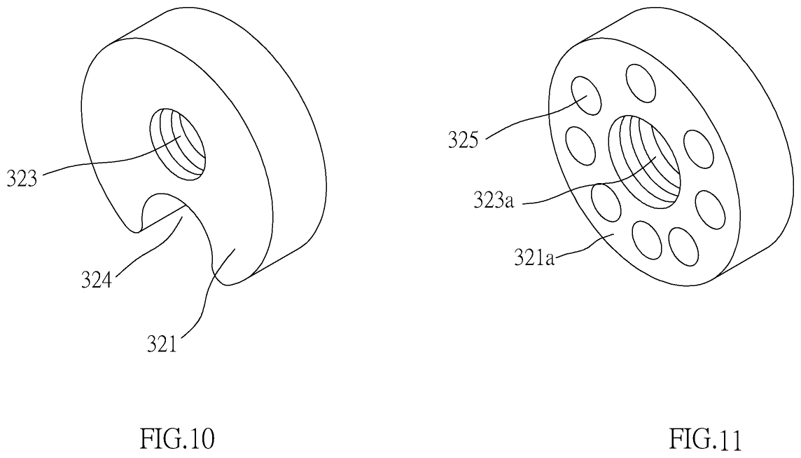

As shown in FIG. 10, in the current embodiment, the regulating member 32 includes a cover 321 and a guiding path, wherein the cover 321 is circular and has a threaded hole 323 in a center of the cover 321. The threaded section 364a of the driven shaft 364 passes through the threaded hole 323 and screws into the threaded hole 323. A peripheral edge of the cover 321 has a notch 324. In the current embodiment, a plurality of extending shafts 322 which is parallel to the driven shaft 364 constitute the guiding path, wherein an end of each of the extending shafts 322 is connected to a peripheral edge of the main exhaust pipe 12, while another end thereof is located outside of the main outlet 12a, and the cover 321 is located between the extending shafts 322.

The manner about how the displacement exhausted from the exhaust pipe body 10 is regulated by the displacement regulating device 2 for reducing the noise will be described in detail as follow, and the performance will be described later.

FIG. 7 shows that the cover 321 is located at the first position P1. At this time, the restoring member 363 is in an unstretched state, and the cover 321 keeps staying at the first position P1 that is adjacent to the main outlet 12a.

FIG. 8 shows that a control end 34b of the operating member 34 is moved toward a rear of the motorcycle 100. At this time, the operating member 34 pushes the movable shaft 362 to move toward the rear of the motorcycle 100 and pulls the restoring member 363, whereby to drive the cover 321 which is screwed into the driven shaft 364 to move outward. In this way, the cover 321 horizontally moves along the extending shafts 322, wherein the horizontal movement of the cover 321 implied that the cover 321 is moved in a fixed configuration in a direction parallel to an axial direction of the extending shafts 322, instead of pivoting movement.

FIG. 9 shows that the cover 321 is indirectly driven by the operating member 34 to move to the second position P2. At this time, the restoring member 363 is stretched to store the reverse force for retracting.

With the position change of the cover 321 and the notch 324 of the cover 321 which communicates inside and outside of the main outlet 12a, when the cover 321 is located at the first position P1, a part of exhaust gas transferred to the attached exhaust pipe 14 passes through the sound-absorbing member 16 to be exhausted from the attached outlet 14a, so that the noise could be reduced. On the contrary, when the cover 321 is located at the second position P2, exhaust gas is not mainly exhausted from the attached outlet 14a, so that the volume reduction effect of the sound-absorbing member 16 is not significant.

In addition, the structure of the cover is not a limitation of the present invention. In an embodiment, a cover 321a with another type, which is also circular and is illustrated in FIG. 11, could be used to achieve the function of reducing the volume and maintaining the exhaust gas. The difference between the cover 321a and the cover 321 shown in FIG. 10 is that, the cover 321a replaces the notch 324 with a plurality of openings 325, so that the displacement of the main outlet 12a could be increased, and a sound wave could be effectively prevented from being transmitted from the main outlet 12a.

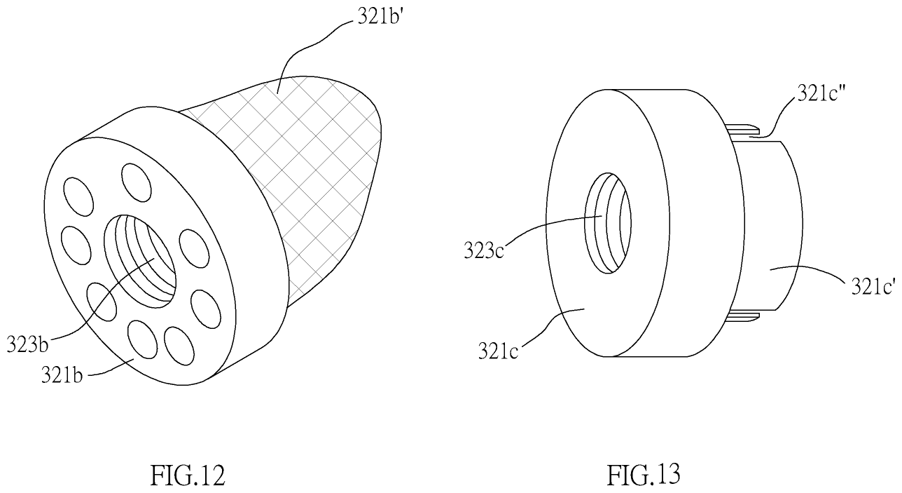

In an embodiment, a cover 321b with still another type, which is illustrated in FIG. 12, could be used. The difference between the cover 321b and the cover 321a shown in FIG. 11 is that, an inner surface of the cover 321b further provided with a sound-absorbing member 321b′, whereby to enhance the performance of reducing the noise volume.

Moreover, in an embodiment, a cover 321c with still another type, which is circular and is illustrated in FIG. 13, could be used to achieve the function of reducing the volume and maintaining the exhaust gas, wherein an inner surface of the cover 321c has a protruding portion 321c′ which is circular. The protruding portion 321c′ has a plurality of openings 321c″. When the cover 321c is located at the first position P1, a peripheral edge of the protruding portion 321c′ abuts against a peripheral edge of the main outlet 12a, and the openings 321c″ on the protruding portion 321c′ communicate inside and outside of the main exhaust pipe 12, so that exhaust gas could be exhausted from the openings 321c″, and the noise could be reduced.

It is worth mentioning that, the aforementioned cover that has the threaded hole could be rotated clockwise or in a counterclockwise direction to move forward or backward on the threaded section 364a of the driven shaft 364, whereby to adjust a distance between the cover and the main outlet 12a. In this way, the degree of closure of the main outlet 12a could be fine-tuned through the cover.

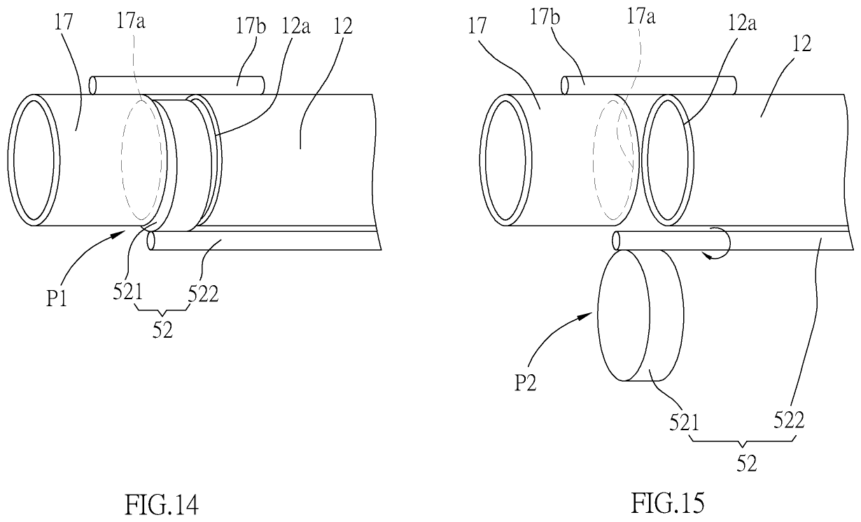

In addition to using the structure of the aforementioned regulating member which is pivotally connected or is screwed for blocking exhaust gas and changing the flow direction, there is a regulating member 52 of a third embodiment according to the present invention illustrated in FIG. 14 and FIG. 15.

As shown in FIG. 14, the regulating member 52 includes a circular cover 521 and a rotatable shaft 522, wherein a side of the cover 521 is fixed on the rotatable shaft 522, and the rotatable shaft 522 is operable by an operating device (not shown) to spin, so that the cover 521 could rotate around the rotatable shaft 522. In addition, in the current embodiment, the exhaust pipe body 10 further includes an extending tube 17, and an outer peripheral surface of the extending tube 17 has a plurality of connecting rods 17b engaged with an outer peripheral surface of the main exhaust pipe 12, wherein the extending tube 17 is located outside of the main outlet 12a, whereby to form a receiving space between the main exhaust pipe 12 and the extending tube 17. The cover 521 is located between the main exhaust pipe 12 and the extending tube 17, and two lateral surfaces of the cover 521 respectively face the main outlet 12a and an inlet 17a of the extending tube 17.

As shown in FIG. 14, when the cover 521 is located at a first position P1, the main outlet 12a and the inlet 17a of the extending tube 17 are shielded by the lateral surfaces of the cover 521, so that the displacement of exhaust gas passing therethrough is lowered.

As shown in FIG. 15, the cover 521 of the regulating member 52 is rotated toward the second position P2 and away from the first position P1 by the rotatable shaft 522. During the process of changing the position of the regulating member 52, the main outlet 12a is gradually no longer shielded by the cover 521, so that the displacement of exhaust gas passing through the extending tube 17 could be increased.

With the position change of the cover 521, when the cover 521 is gradually rotated toward the first position P1, the main outlet 12a is gradually shielded by the cover 521, so that a part of exhaust gas is transferred to the attached exhaust pipe 14 and passes through the sound-absorbing member 16 to be exhausted from the attached outlet 14a, whereby to reduce the noise volume. On the contrary, when the cover 521 is gradually rotated toward the second position P2, exhaust gas is not mainly exhausted from the attached outlet 14a, so that the volume reduction effect of the sound-absorbing member 16 is not significant.

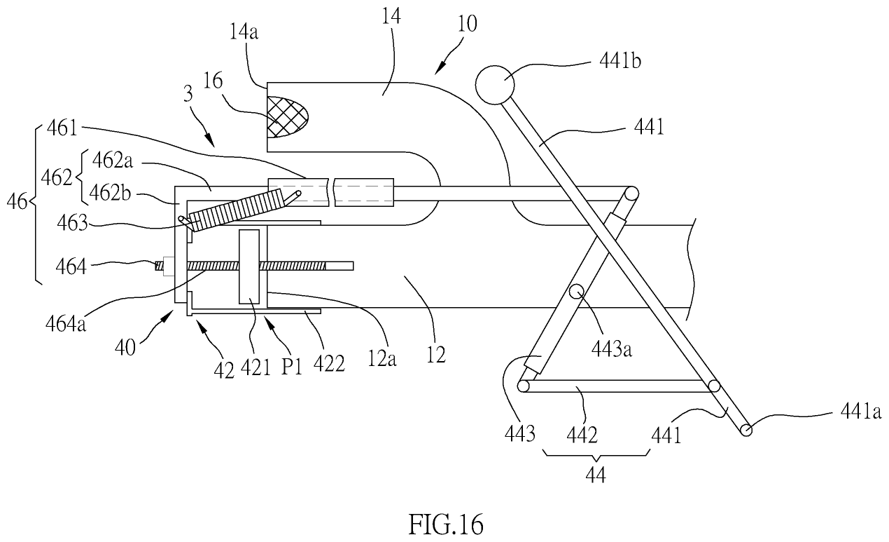

An operating member 44 with another type is illustrated in FIG. 16, wherein the difference between the operating member 44 and that of the aforementioned embodiments is that, the operating member 44 includes an operating shaft 441, a connecting rod 442, and a retractable shaft 443. The operating shaft 441 has a control end 441b and a pivot end 441a which are opposite, wherein the pivot end 441a is pivotally connected to a predetermined portion of the motorcycle 100, and the control end 441b is adapted to be held by the rider for moving the operating shaft 441 back and forth. An end of the connecting rod 442 is pivotally connected to the operating shaft 441 and is located between the control end 441b and the pivot end 441a, while another end thereof is pivotally connected to an end of the retractable shaft 443. Another end of the retractable shaft 443 is pivotally connected to an end of a flat segment 462a of a movable shaft 462, wherein a middle section of the retractable shaft 443 has a pivot end 443a pivotally connected to a predetermined portion of the motorcycle 100.

FIG. 16 shows that a cover 421 is located at the first position P1. At this time, a restoring member 463 is in an unstretched state, and the cover 421 keeps staying at the first position P1 that is adjacent to the main outlet 12a.

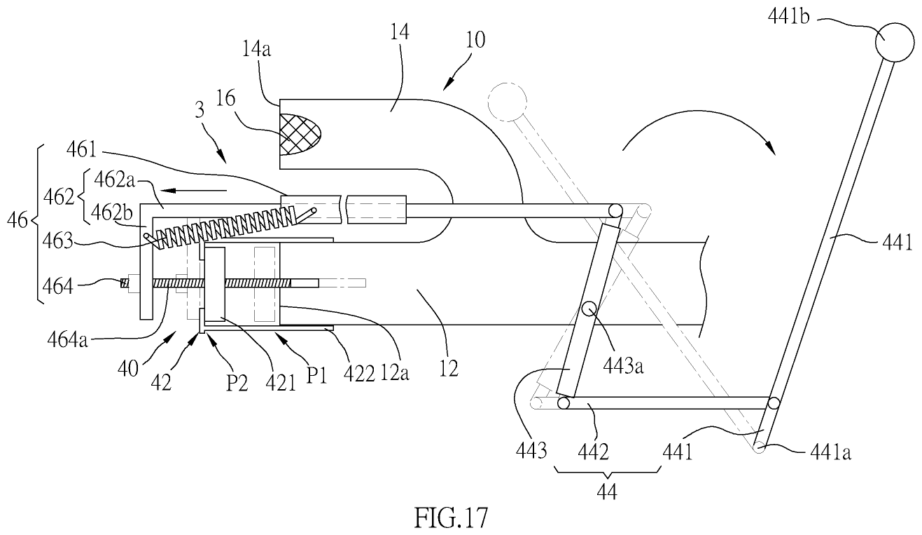

FIG. 17 shows that the control end 441b of the operating shaft 441 is moved toward a front of the motorcycle 100. At this time, the operating shaft 441 pulls the another end of the connecting rod 442 to move toward a front of the motorcycle 100. The retractable shaft 443 rotates around the pivot end 443a in a counterclockwise direction, so as to drive the flat segment 462a of the movable shaft 462, which is pivotally connected to the another end of the retractable shaft 443, to move toward a rear of the motorcycle 100 and pull the restoring member 463, whereby to drive the cover 421 to move outward. In this way, the cover 421 could horizontally move along extending shafts 422.

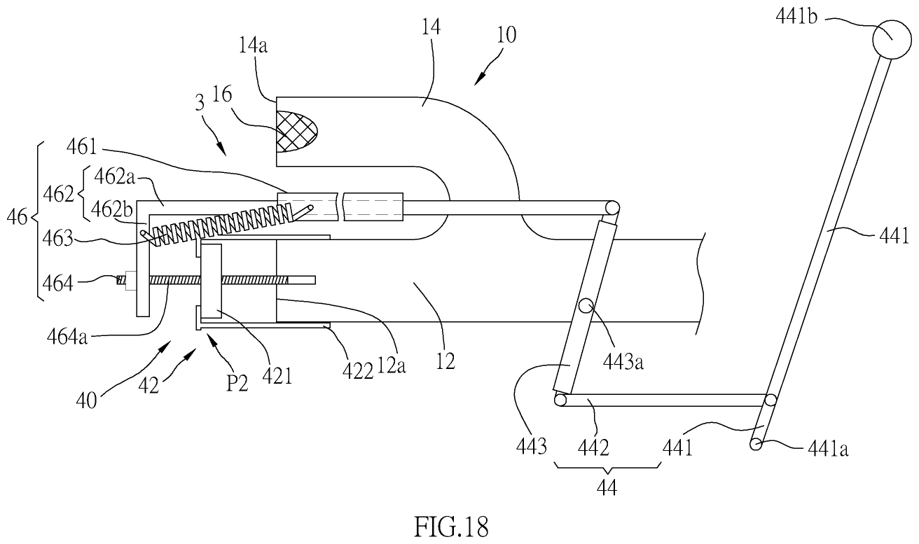

FIG. 18 shows that the cover 421 is indirectly driven by the operating member 44 to horizontally move to the second position P2. At this time, the restoring member 463 is stretched to store the reverse force for retracting.

In this way, when the control end 441b of the operating shaft 441 is moved toward a front of the motorcycle 100, the cover 421 horizontally moves toward the second position P2 that is away from the first position P1; when the control end 441b of the operating shaft 441 moves toward the rear of the motorcycle 100, the cover 421 horizontally moves toward the first position P1 that is away from the second position P2.

With the aforementioned design, the displacement regulating device could drive the linking assembly via the operating member so as to move the regulating member to be located at the first position that is adjacent to the main outlet or at the second position that is away from the main outlet. In addition, the operating member could be positioned via the locking member (not shown), whereby to keep the regulating member at the second position. In this way, the exhaust pipe of the vehicle controlled by the displacement regulating device could operate either in a low noise volume state or in a normal state that the noise volume is not restricted.

In conclusion, by disposing the regulating member and the operating device on the exhaust pipe, the displacement regulating device of the present invention could significantly reduce the noise volume, lowering the disturbances to the people.

It must be pointed out that the embodiments described above are only some preferred embodiments of the present invention. All equivalent structures which employ the concepts disclosed in this specification and the appended claims should fall within the scope of the present invention.

What is claimed is:

1. A displacement regulating device, which is adapted to be disposed on an exhaust pipe body of a vehicle, wherein the exhaust pipe body has at least one outlet; the displacement regulating device comprising:
a regulating member which is adapted to be movably disposed inside or outside of the exhaust pipe body; and
an operating device which is engaged with the regulating member and is operable to drive the regulating member to move between a first position and a second position, wherein the first position is adjacent to the at least one outlet, and the second position is away from the at least one outlet.

2. The displacement regulating device of claim 1, wherein the regulating member has a first end and a second end which are opposite; when the regulating member is at the second position, the first end is adjacent to a peripheral edge of the at least one outlet of the exhaust pipe body, and the second end of the regulating member and the peripheral edge of the at least one outlet are spaced from each other by a distance.

3. The displacement regulating device of claim 1, wherein the operating device comprises an operating member and a linking assembly, and the linking assembly engages the operating member and the regulating member; when the operating member is operated, the linking assembly drives the operating member to move between the first position and the second position.

4. The displacement regulating device of claim 3, wherein the regulating member comprises a cover; the cover has the first end and the second end and is controlled by the operating member to pivot around the first end, whereby to move between the first position and the second position.

5. The displacement regulating device of claim 4, wherein the linking assembly comprises a movable shaft and an abutting rod, and the movable shaft is engaged with the second end of the cover; the abutting rod is engaged with the movable shaft; when the cover is at the first position, the abutting rod abuts against an outer surface of the cover.

6. The displacement regulating device of claim 5, wherein the linking assembly further comprises a restoring member, and the restoring member provides a reverse force to urge the cover to move toward the first position.

7. The displacement regulating device of claim 4, wherein the cover has at least one opening; when the cover is located at the first position, the at least one opening communicates inside and outside of the exhaust pipe body.

8. The displacement regulating device of claim 1, wherein the regulating member comprises a cover and a guiding path, and the cover is controlled by the operating member to horizontally move between the first position and the second position via the guiding path.

9. The displacement regulating device of claim 8, wherein the operating device comprises an operating member and a linking assembly, and the linking assembly engages the operating member and the regulating member, and has a driven shaft which is driven by the operating member to move relative to the exhaust pipe body; the cover is disposed on the driven shaft, wherein the guiding path comprises at least one extending shaft disposed in parallel with the driven shaft; the cover moves along with an extending direction of the at least one extending shaft.

10. The displacement regulating device of claim 9, wherein the driven shaft has a threaded section, and the cover has a threaded hole which is screwed to the threaded section.

11. The displacement regulating device of claim 10, wherein the guiding path comprises a plurality of extending shafts; an end of each of the extending shafts is connected to a peripheral edge of the exhaust pipe body, while another end thereof extends outside of the at least one outlet; the cover is located between the extending shafts.

12. The displacement regulating device of claim 8, wherein the linking assembly further comprises a restoring member, and the restoring member provides a reverse force to urge the cover to move toward the first position.

13. The displacement regulating device of claim 8, wherein the cover has at least one opening; when the cover is located at the first position, the at least one opening communicates inside and outside of the exhaust pipe body.

14. The displacement regulating device of claim 8, wherein an inner surface of the cover has a protruding portion, and the protruding portion has at least one opening; when the cover is located at the first position, the at least one opening communicates inside and outside of the exhaust pipe body.

15. The displacement regulating device of claim 8, wherein the regulating member comprises a sound-absorbing member connected to the cover, and at least a part of the sound-absorbing member is located inside of the exhaust pipe body.

16. The displacement regulating device of claim 1, wherein the regulating member comprises a cover and a rotatable shaft, and the cover is engaged with the rotatable shaft; when the cover is controlled by the rotatable shaft to rotate around an axial direction of the rotatable shaft from the second position to the first position, an exhaust gas exhausted from the at least one outlet is gradually shielded by the cover.

17. The displacement regulating device of claim 16, further comprising an extending tube disposed outside of the at least one outlet, wherein the extending tube is adapted to be engaged with the exhaust pipe body, and the exhaust gas exhausted from the at least one outlet passes through the extending tube.

18. The displacement regulating device of claim 17, wherein when the cover is located at the first position, the cover is located between the extending tube and the exhaust pipe body; when the cover is located at the second position, the cover is not located between the extending tube and the exhaust pipe body.

19. The displacement regulating device of claim 1, wherein the exhaust pipe body comprises a main exhaust pipe and an attached exhaust pipe, and the at least one outlet comprises a main outlet and an attached outlet; the main outlet is located on the main exhaust pipe, and the attached outlet is located on the attached exhaust pipe; when the regulating member of the displacement regulating device is located at the first position, the regulating member is adjacent to the main outlet; at this time, a displacement of the main outlet minus a displacement of the attached outlet is defined as a first difference; when the regulating member of the displacement regulating device is located at the second position, the regulating member is away from the main outlet; at this time, the displacement of the main outlet minus the displacement of the attached outlet is defined as a second difference; the first difference is smaller than the second difference.

20. The displacement regulating device of claim 19, wherein an inside of the attached outlet which is adjacent to a peripheral edge of the attached outlet has a sound-absorbing member.
